(19) United States
(12) Patent Application Publication
(10) Pub. No.: US 2024/0324526 A1
(43) Pub. Date: Oct. 3, 2024

(54) SYSTEM AND METHOD FOR PROGRAMMING IRRIGATION CONTROLLERS

(71) Applicant: Rain Bird Corporation, Azusa, CA (US)

(72) Inventors: Joseph G. Porrazzo, JR., Sahuarita, AZ (US); James R. Harris, Tucson, AZ (US)

(21) Appl. No.: 18/614,526

(22) Filed: Mar. 22, 2024

Related U.S. Application Data
(60) Provisional application No. 63/456,389, filed on Mar. 31, 2023.

(51) Int. Cl. A01G 25/16

(52) U.S. Cl. CPC A01G 25/16

(57) ABSTRACT

Systems, apparatuses, and methods are provided herein related to programming irrigation controllers. In some embodiments, a system for programming irrigation controllers includes an irrigation control application stored on a memory of a mobile electronic device. The irrigation control application can allow the user to create, save, and edit an irrigation schedule template and allow the user to transmit the irrigation schedule template to one or more irrigation controllers. The irrigation control application can store the irrigation schedule template in the memory of the mobile electronic device, but the application does not save the irrigation schedule template at a remote irrigation server.

### CROSS-REFERENCE TO RELATED APPLICATIONS

This application claims the benefit of U.S. Provisional Application No. 63/456,389 filed Mar. 31, 2023 (Docket No. 8473-154716-US), which is incorporated herein by reference in its entirety.

### TECHNICAL FIELD

This invention relates generally to irrigation systems and, more particularly, to the programming of irrigation controllers.

### BACKGROUND

Irrigation controllers cooperate with irrigation valves on a property to irrigate the property. For example, irrigation controllers are used to control the delivery of water to irrigation devices connected to switchable irrigation valves. Some irrigation controllers allow a user to define a schedule that the irrigation controller implements to control the valves. An irrigation schedule can be defined by irrigation parameters such as a watering day, a start time, a watering duration, a watering frequency, etc. Typically, the user interacts with the irrigation controller through a control panel located on the irrigation controller. Consequently, the user needs to be present at the irrigation controller to interact with the irrigation controller (e.g., manipulate the buttons, dials, switches, etc. included in the control panel). Further, when the user defines an irrigation schedule for more than one irrigation controller, the user needs to define the irrigation schedule for each irrigation controller repetitively. Being present at an irrigation controller and defining the irrigation schedule for every irrigation controller repetitively can be difficult and inconvenient for a user.

### BRIEF DESCRIPTION OF DRAWINGS

Disclosed herein are embodiments of systems, apparatuses, methods user interfaces, and controls relating to programming irrigation controllers. This description includes drawings, wherein:

FIG. 1 depicts a system for programming irrigation controllers where a mobile electronic device communicates with one of the irrigation controllers via more than one communication mode, according to some embodiments.

FIG. 2 depicts a system for programming irrigation controllers where a mobile electronic device wirelessly communicates with a plurality of irrigation controllers, according to some embodiments.

FIG. 3 depicts a block diagram of a system for programming a plurality of irrigation controllers, according to some embodiments.

FIG. 4 is a flow chart depicting example operations of the irrigation control applications for programming irrigation controllers, according to some embodiments.

FIG. 5 depicts an example graphical user interface (GUI) providing an option to create an irrigation schedule template and an option to load the irrigation schedule template, according to some embodiments.

FIG. 6 depicts an example GUI allowing the user to enter irrigation parameters for the irrigation schedule template, according to some embodiments.

FIG. 7 depicts an example GUI for setting up an irrigation controller, according to some embodiments.

FIG. 8 depicts an example GUI depicting a list of a plurality of irrigation schedule templates, according to some embodiments.

FIG. 9 depicts a block diagram of an example irrigation controller, according to some embodiments, according to some embodiments.

FIG. 10 illustrates an exemplary system for use in implementing methods, techniques, devices, apparatuses, systems, servers, and sources and providing control over irrigation, according to some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments. Also, common but well-understood elements that are useful or necessary in a commercially feasible embodiment are often not depicted in order to facilitate a less obstructed view of these various embodiments. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

The following description is not to be taken in a limiting sense, but is made merely for the purpose of describing the general principles of exemplary embodiments. Reference throughout this specification to “one embodiment,” “an embodiment,” “some embodiments”, “an implementation”, “some implementations”, “some applications”, or similar language means that a particular feature, structure, or characteristic described in connection with the embodiment is included in at least one embodiment of the invention. Thus, appearances of the phrases “in one embodiment,” “in an embodiment,” “in some embodiments”, “in some implementations”, and similar language throughout this specification may, but do not necessarily, all refer to the same embodiment.

Generally speaking, pursuant to various embodiments, systems, apparatuses and methods are provided herein useful to define and/or set up an irrigation schedule. As previously discussed, when a user owns, controls or has access to program more than one irrigation controller, an irrigation schedule should be defined for each controller. Defining the same or similar irrigation schedule for every irrigation controller repetitively can be inconvenient and time consuming for a user. Embodiments of the systems, methods, and apparatuses described herein allow a user to define an irrigation schedule for more than one irrigation controller using an irrigation schedule template saved in a memory of a mobile electronic device and allow a user to avoid defining the same or similar irrigation schedules repetitively.

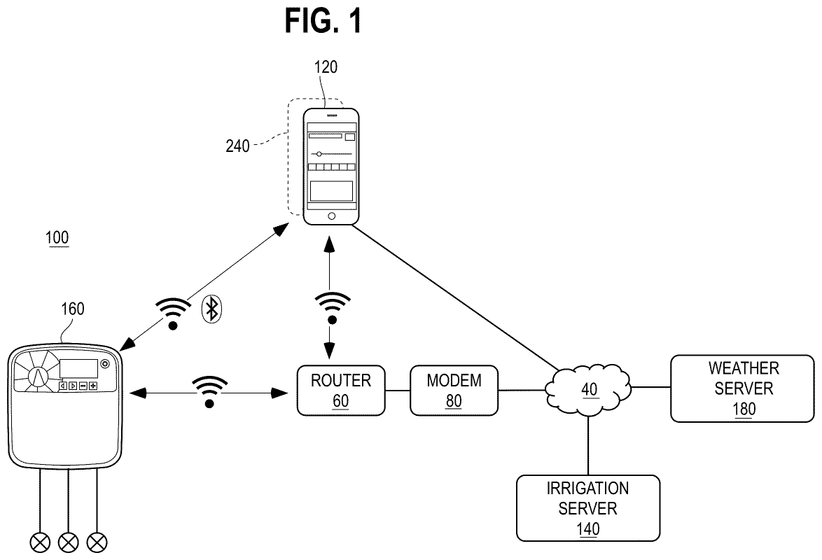

FIG. 1 depicts a system 100 for programming irrigation controllers where a mobile electronic device communicates with one of the irrigation controllers via more than one communication mode, according to some embodiments. The system 100 depicted in FIG. 1 includes a mobile electronic device 120, an irrigation controller 160, a router 60, a modem 80, a communications network 40 (e.g., the Internet), a remote irrigation server 140, and a weather server 180. The mobile electronic device 120 includes an irrigation control application 240 stored in the memory of the mobile electronic device 120. The irrigation control application 240 can wirelessly communicate, via the mobile electronic device 120, with the irrigation controller 160.

According to some embodiments, the mobile electronic device 120 can communicate with an irrigation controller 160 via more than one communication mode. In some embodiments, the mobile electronic device 120 connects directly to and communicates directly with the irrigation controller 160. For example, the irrigation controller 160 can create a local network (e.g., a network that conforms to the 802.11 standards) and the mobile electronic device 120 can directly connect to the irrigation controller 160 via the local network created by the irrigation controller 160. In one embodiment, the irrigation controller 160 and the mobile electronic device 120 can be connected via Bluetooth pairing. These direct communications are useful because it only requires two devices, i.e., the irrigation controller 160 and the mobile electronic device 120. It is also useful where an internet connection has failed or is not available. In some embodiments, the mobile electronic device 120 can indirectly communicate with the irrigation controller 160 via a local access point. In one embodiment, the local access point is the router 60 and the router 60 creates a local network. In some embodiments, the mobile electronic device 120 can indirectly communicate with the irrigation controller 160 via a wide area network (“WAN”). In one embodiment, the irrigation controller can connect to the WAN via the router 60, the modem 80, and the communication network 40. The WAN can include the remote irrigation server 140 and the weather server 180. In some embodiments, the mobile electronic device 120 can communicate with the irrigation controller 160 via one or more of a local access point, a local gateway, a cellular network, an internet, and a satellite network. In some embodiments, the wireless transceiver/s of the irrigation controller 160 are integrated into the controller or can be removably connected to the irrigation controller 160. Further examples of wireless connections with an irrigation controller are described in U.S. Pat. No. 11,089,746, issued Aug. 17, 2021, which is incorporated herein by reference.

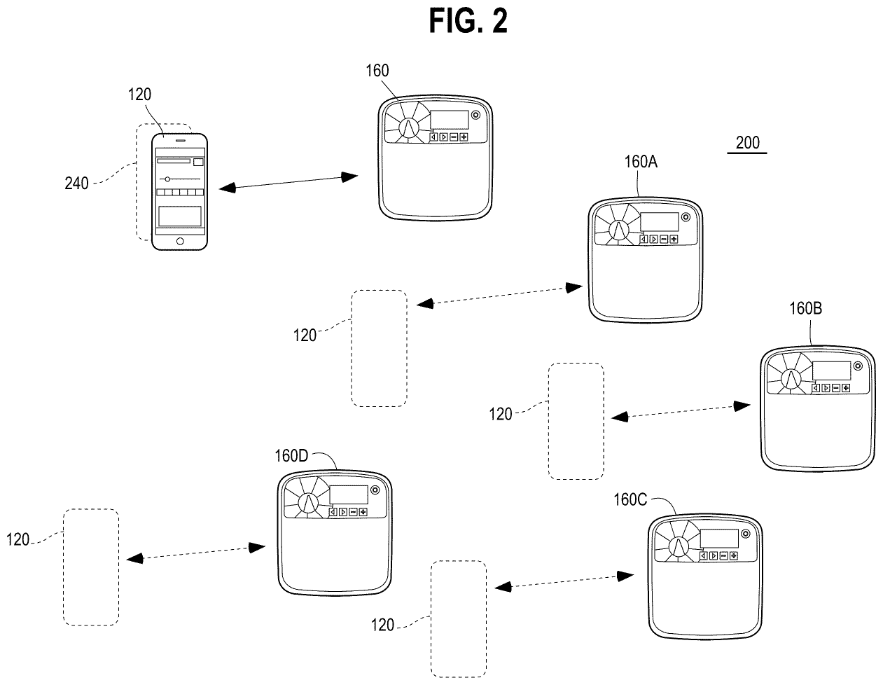

FIG. 2 depicts a system 200 for programming irrigation controllers where the mobile electronic device 120 wirelessly communicates with a plurality of irrigation controllers 160, 160A-D. According to some embodiments, the irrigation control application 240 can wirelessly communicate, via the mobile electronic device 120, with each of a plurality of the irrigation controllers 160, 160A, 160B, 160C, 160D one at a time. For example, the irrigation control application 240 can wirelessly communicate with a first one 160 of the plurality of irrigation controllers and then wirelessly communicate with a second one 160A of the plurality of irrigation controllers. The irrigation control application also can communicate with the next ones 160B, 160C, 160D of the plurality of irrigation controllers one at a time. Although FIG. 2 depicts that the irrigation control application 240 communicates with five irrigation controllers 160, 160A-D, this is not required and is shown by way of example. For example, the irrigation control application 240 can communicate with fewer or more than five irrigation controllers.

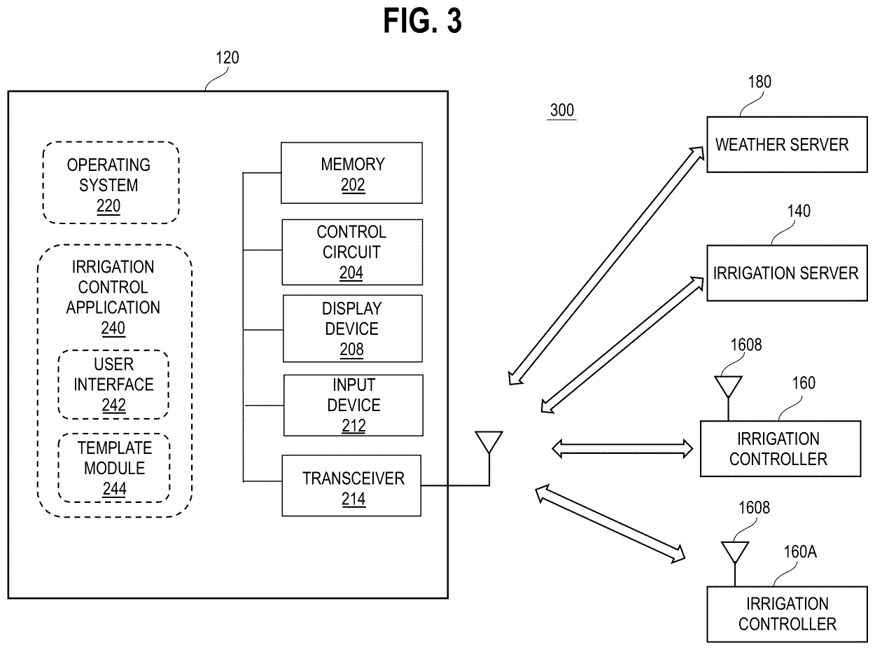

FIG. 3 depicts a block diagram of a system 300 for programming irrigation controllers 160, 160A, according to some embodiments. The mobile electronic device 120 can communicate with each of the plurality of irrigation controllers 160, 160A, a remote irrigation server 140, and a weather server 180. The mobile electronic device 120 includes a memory device 202, a control circuit 204 (e.g., a processor), a display device 208, an input device 212, and a transceiver 214. Although FIG. 3 depicts the display device 208 and the input device 212 as distinct components, this is not required. For example, the display device 208 and the input device 212 can be integrated into a single device receiving input and presenting output, such as a touchscreen.

The memory device 202 stores software, such as an operating system code and an irrigation control application code. Although FIG. 3 depicts the irrigation control application 240 and the operating system 220 as separate, the irrigation control application 240 can be an application integrated into the operating system 220 of the mobile electronic device 120. Alternatively, the irrigation control application 240 can be an add-on application separate from the operating system 220 and installed on the mobile electronic device 120. The control circuit 204 can access the memory device 202 and execute the irrigation control application 240 stored in the memory device 202.

In some embodiments, the irrigation control application 240 includes a user interface 242 and a template module 244. The user interface 242 includes graphical user interfaces (GUIs). In some embodiments, the template module 244 can be configured to create, save, load, edit, manage and delete irrigation schedule templates. In some embodiments, the template module 244 can load the irrigation schedule template when the mobile electronic device 120 transmits the irrigation schedule template to the irrigation controllers 160, 160A. For example, the template module 244 can receive irrigation parameters entered, via the user interface 242, by the user for each field of the irrigation template, create the irrigation schedule template with the irrigation parameters, and save the irrigation schedule template in the memory 202 of the mobile electronic device 120. The template module 244 can load the irrigation schedule template having been saved and can edit the template by receiving new irrigation parameters from the user for the field of the irrigation template. The template module 244 can delete the irrigation templates having been saved in the memory device 202.

In some embodiments, the display device 208 presents the user interface 242 for the irrigation control application 240 (e.g., based on the application code). The input device 212 receives user input via the user interface 242, and provides the user input, in the form of commands, to the irrigation control application 240. The control circuit 204 executes codes (e.g., the operating system code 220 and the irrigation control application code 240) and provides commands to other components of the mobile electronic device 120.

In some embodiments, the transceiver 214 can be configured for wireless, satellite, or other such communication configurations or combinations of two or more such communications. For example, the transceiver 214 allows the mobile electronic device 120 to communicate wirelessly. By doing so, the irrigation control application 240 can communicate wirelessly, via the mobile electronic device 120, with the irrigation controllers 160, 160A, the remote irrigation server 140, the weather server 180, or any other wireless devices (e.g., access points, communication network, etc.).

Referring to FIG. 1 and FIG. 3, in some embodiments, the remote irrigation server 140 determines and transmits weather-based corrections to the irrigation controllers 160, 160A. The remote irrigation server 140 can obtain historical and predicted weather information from the weather server 180. The weather information can include temperatures, humidity, wind speed, solar radiation, rainfall, etc. Based on the historical weather information (e.g., temperature, humidity, wind speed, solar radiation, rainfall, etc.), the remote irrigation server 140 can determine an evapotranspiration (ET) value using any known approach. As is well known, ET is typically determined using values of temperature, humidity, wind speed, and solar radiation. ET values are then often adjusted based on rainfall data. ET values and rainfall can be used to determine whether any scheduled watering should be reduced or increased. Additionally, if it is predicted to rain and/or be colder than normal in a given area, then the remote irrigation server 140 can determine whether to reduce or suspend future scheduled irrigation. Conversely, if the weather patterns are warmer and/or dryer than normal for a given area, the remote irrigation server 140 can determine that scheduled watering should be increased. In some embodiments, the remote irrigation server 140 calculates a weather adjustment factor and transmits the weather adjustment factor to the irrigation controllers 160, 160A. In some embodiments, the remote irrigation server 140 determines the weather adjustment factors based on geographic location (e.g., state, county, city, zip code, etc.), received or calculated weather or ET information, and so on. In such embodiments, the remote irrigation server 140 transmits the weather adjustment factors based on the geographic locations. For example, the remote irrigation server 140 can transmit geographic-based weather adjustment factors to all irrigation controllers in a zip code.

In some embodiments, the remove irrigation server 140 can transmit the weather adjustment factors to the mobile electronic device 120 having the irrigation control application 240. The irrigation control application 240 can receive the weather adjustment signaling from the remote irrigation server.

Not all irrigation controllers include the functionality to accept weather adjustment factors. For example, some irrigation controllers may only include the functionality to accept “seasonal adjustment values” (i.e., a value, such as a percentage, that an irrigation controller uses to scale any scheduled watering duration). As an example, a seasonal adjust value of 80% will signal to the irrigation controller 160 to reduce the scheduled watering duration by 20% (i.e., 80% of the scheduled watering duration). That is, if watering was scheduled for 10 minutes, an 80% seasonal adjustment will result in watering for only 8 minutes. A seasonal adjust value of 0% will cause the irrigation controller 160 to not irrigate (i.e., there would be 0 minutes of watering). A seasonal adjust value of 150% will signal to the irrigation controller 160 to increase the scheduled watering duration by 50% (i.e., 150% of the scheduled watering duration). In this example, a seasonal adjust value of 150% would result in 15 minutes of watering.

In some embodiments, since ET calculations are based in part on weather forecasts, the weather forecast data is later compared to actual historical data for the forecast period and used to make any adjustments in the next weather adjustment factor to be sent to the irrigation controller 160. That is, if the weather forecast for tomorrow indicates cooler weather than normal, this may result in a weather adjustment factor that reduces irrigation. However, if the weather actually was not cooler than normal, the weather adjustment for the next day can be adjusted to include more irrigation than would otherwise be needed (to account for the under-irrigation due to incorrectly forecast data).

In some embodiments, the irrigation control application 240 is a client device application. The mobile electronic device 120 can download the irrigation control application 240 from a server or the mobile electronic device 120 may be provided with the irrigation control application 240 pre-installed. The irrigation control application 240 is stored on the memory 202 of the mobile electronic device 120 and executed by the processor 204 of the mobile electronic device. The irrigation control application 240 can wirelessly communicate, via the mobile electronic device 120, with a remote irrigation server 140, weather server 180, and a plurality of irrigation controllers 160, 160A. In some embodiments, the irrigation controller 160 can transmit information regarding the irrigation controller type to the mobile electronic device 120. The irrigation controller application 240 can use this information to configure settings, images, controls, etc. of the application 240. For example, the irrigation control application 240 can present a representative image of the irrigation controller 160, the type of the irrigation controller 160, and one or more controls specific to the type of irrigation controller 160.

In some embodiments, the irrigation control application 240 allows the user to interact with the irrigation controller 160 via the user interface 242. The application 240 allows the user to view information output from the irrigation controller 160, such as scheduling and programming information. The application 240 allows the user to create watering schedules, edit the watering schedules, start and stop manual watering, adjust seasonable adjustment values, and so on. The irrigation control application 240 provides a convenient interface for the user to program the irrigation controller 160 without having to be present at the irrigation controller 160.

In some embodiments, the irrigation control application 240 allows a user to create an irrigation schedule template, enter irrigation parameters for fields of the irrigation schedule template, and save the irrigation schedule template with the irrigation parameters. For example, when the user enters irrigation parameters, via the user interface 242, the irrigation control application 240, via the user interface 242 and template module 244, receives the irrigation parameters, fills out each field of the irrigation schedule template with the entered irrigation parameters and creates the irrigation schedule template. According to some embodiments, the irrigation control application 240 can save numerous irrigation parameters (such as a watering day, a start time, a watering duration, a watering frequency, and a seasonal adjustment) as a single irrigation schedule template. In some embodiments, the irrigation control application 240 can create more than one irrigation schedule template and save them.

In some embodiments, the irrigation control application 240 allows the user to load the irrigation schedule template having been saved. For example, when the user, via the user interface 242, selects to load the irrigation template, the irrigation control application 240 loads, via template module 244, the irrigation schedule template and shows, via the user interface 242, the loaded irrigation schedule template to the user. By loading the irrigation template having been saved, the user does not need to enter each irrigation parameter again to define the irrigation schedule.

In some embodiments, the irrigation control application 240 allows, via the user interface 242 and the template module, the user to edit the irrigation schedule template. For example, when the user loads the irrigation schedule template and edits the irrigation parameters, via the user interface 242, by deleting the original irrigation parameters and entering the new irrigation parameters, the template module 244 replaces the original irrigation parameters with the newly entered parameters for the fields of the irrigation template. Editing the irrigation schedule template is useful when the user needs a new irrigation schedule that is similar to the irrigation schedule having been saved as an irrigation schedule template. By editing the irrigation schedule template which has been saved instead of creating a new irrigation schedule template, the user can avoid entering the irrigation parameter repetitively to define a similar irrigation schedule. In some embodiments, the irrigation control application 240 allows the user to save the edited irrigation template as a new irrigation schedule template while maintaining the original irrigation schedule template having been saved.

In some embodiments, the irrigation control application 240 allows the user to delete the irrigation schedule template. For example, when the user selects, via the user interface 242, to delete the irrigation schedule template having been saved, the template module 244 deletes the irrigation schedule template from the memory 202 of the mobile electronic device 120.

In some embodiments, the irrigation control application 240 allows the user to transmit the irrigation schedule template to the irrigation controller 160. For example, when the user selects, via the user interface 242, to transmit the irrigation schedule template to the irrigation controller 160, the irrigation control application 240 causes the mobile electronic device 120 to wirelessly transmit the irrigation schedule template to the irrigation controller 160. When the irrigation controller 160 receives the irrigation schedule template, the irrigation controller 160 saves and executes the irrigation schedule defined by the parameters of the irrigation schedule template.

In some embodiments, the irrigation control application 240 allows the user to transmit the irrigation schedule template to one or more irrigation controllers 160, 160A. Although FIG. 3 depicts that the mobile electronic device 120 having irrigation control application 240 communicates with two irrigation controllers 160, 160A, this is not required. For example, the irrigation control application 240 can cause the mobile electronic device 120 to transmit the irrigation schedule template to more than two irrigation controllers. The user can define irrigation parameters for one or more irrigation controllers by transmitting a single irrigation schedule template to each of the irrigation controllers. Before transmitting the irrigation schedule template to each irrigation controller, the user can load and edit the irrigation schedule template having been saved. Alternatively, using the irrigation control application, the user can create an irrigation schedule template and transmit it to the plurality of the irrigation controllers without editing the irrigation schedule template. Using the irrigation template is advantageous when the user configures more than one irrigation controller with the same or similar irrigation schedules. According to some embodiments, the user does not need to enter the same irrigation parameters again.

In some embodiments, the irrigation control application 240 provides the user an option to manage the irrigation schedule templates. In the managing mode, the user can see the list of the irrigation schedule templates having been saved and can edit or delete the irrigation schedule templates.

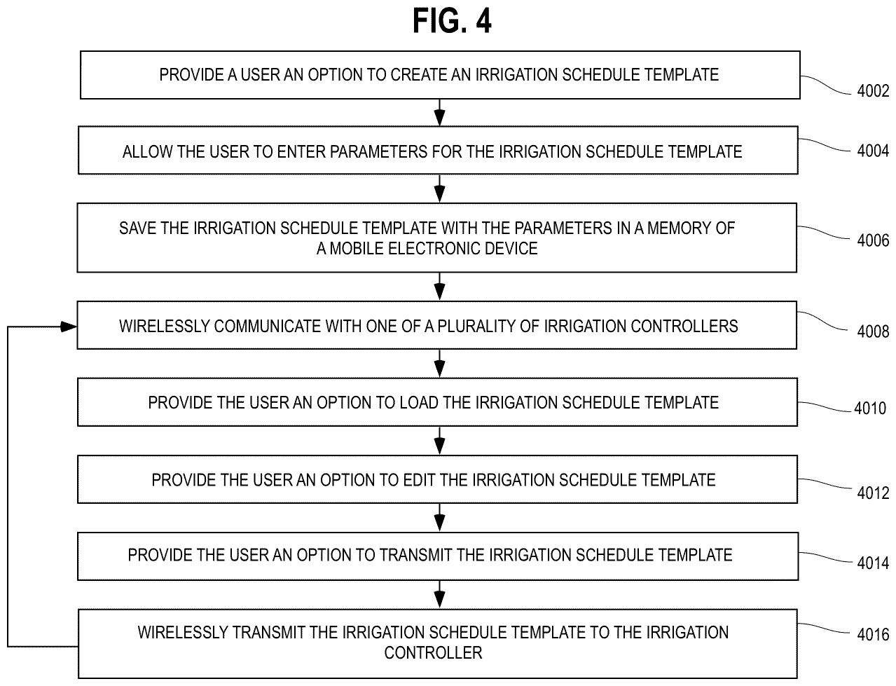

FIG. 4 is a flow chart depicting example operations of the irrigation control applications for programming irrigation controllers, according to some embodiments. The flow begins at block 4002.

At block 4002, the irrigation control application provides, via a user interface and using a template module, a user an option to create an irrigation schedule template. The user can select to create an irrigation schedule template. The flow continues at block 4004.

At block 4004, the irrigation control application allows, via the user interface and using the template module, the user to enter parameters for the irrigation schedule template. The user can enter the parameters via the user interface of the irrigation control application and the irrigation control application can receive the entered parameters via the user interface and using the template module. The flow continues at block 4006.

At block 4006, the irrigation control application saves, using the template module, the irrigation schedule template with the parameters. The irrigation control application saves the irrigation schedule template in a memory of a mobile electronic device but does not save it at a remote irrigation server. The flow continues at block 4008.

At block 4008, the irrigation control application wirelessly communicates with a first one of a plurality of irrigation controllers. The wireless communication can use one or more direct wireless communication with one or more of the plurality of irrigation controllers, indirect wireless communication with one or more of the plurality of irrigation controllers via a local access point, and indirect wireless communication with one or more of the plurality of irrigation controllers via one or more of the local access point, a local gateway, a cellular network, an internet, and a satellite network. The flow continues at block 4010.

At block 4010, the irrigation control application provides, via the user interface and using the template module, the user an option to load the irrigation schedule template having been saved in the memory. The flow continues at block 4012.

At block 4012, the irrigation control application provides, via the user interface and using the template module, the user an option to edit the irrigation schedule template having been loaded. The flow continues at block 4014.

At block 4014, the irrigation control application provides, via the user interface and using the template module, the user an option to transmit the irrigation schedule template to the first one of the plurality of irrigation controllers. The flow continues at block 4016.

At block 4016, the irrigation control application 240 causes the mobile electronic device to wirelessly transmit the irrigation schedule template to the first one of the plurality of irrigation controllers. When the first one of the plurality of irrigation controllers receives the irrigation schedule template, it can save and execute the irrigation schedule defined by the parameters of the irrigation schedule template.

The flow repeats blocks 4008 to 4016 once or more times. In the first repeat of blocks 4008 to 4016, at block 4008, the irrigation control application wirelessly communicates with the next one (e.g., the second one) of the plurality of irrigation controllers; at block 4014, the irrigation control application provides, via the user interface and using the template module, the user an option to transmit the irrigation schedule template to the next one (e.g., the second one) of the plurality of irrigation controllers; and at block 4016, the irrigation control application causes the mobile electronic device to wirelessly transmit the irrigation schedule template to the next one (e.g., the second one) of the plurality of irrigation controllers. After repeating blocks 4008 to 4016 once or more times, the flow ends at block 4016.

Referring back to FIG. 3, in some embodiments, the irrigation control application 240 saves the irrigation schedule templates in the memory 202 of the mobile electronic device 120 but does not save the irrigation schedule templates at the remote irrigation server 140. In some embodiments, the irrigation control application 240 saves the irrigation schedule templates only in the memory 202 of the mobile electronic device 120. According to some embodiments, although the irrigation control application 240 can communicate with the remote irrigation server 140, the irrigation control application 240 does not save the irrigation schedule template at the remote irrigation server 140. According to these embodiments, the irrigation control application 240 allows, via the user interface 242 and using the template module 244, the user to create, save, load, edit, and delete the irrigation schedule template without any signaling to the remote irrigation server 140. The remote irrigation server 140 is not informed of creating, saving, loading, editing, and deleting the irrigation schedule template. Saving the irrigation schedule template at the remote irrigation server 140 requires an internet connection. Saving the irrigation schedule template in the memory of the mobile electronic device 120 is useful because it does not require an internet connection to create, save, load, edit, and delete the irrigation schedule template. Therefore, even when an internet connection to a server has failed or is not available, the user can, via the irrigation control application 240, create, save, load, edit, and delete the irrigation schedule template. According to these embodiments, the user can transmit, via the irrigation control application 240, the irrigation schedule to the irrigation controllers 160, 160A without the internet connection if another method to communicate between the mobile electronic device 120 and irrigation controllers 160, 160A is available (e.g., direct communication).

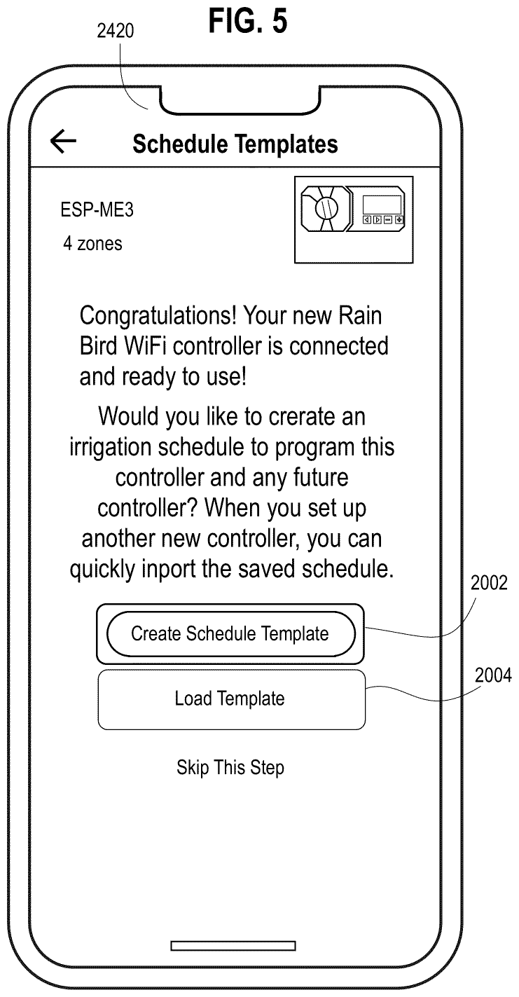

FIG. 5 depicts an example GUI 2420 providing an option to create an irrigation schedule template and an option to load the irrigation schedule template. According to some embodiments, the irrigation control application 240 provides, via the user interface 242 and using a template module 244, the user an option to create an irrigation schedule template and an option to load the irrigation schedule template. For example, the irrigation control application 240 causes the display device 208 to present the GUI 2420 providing the option to create an irrigation schedule template and the option to load the irrigation schedule template. As shown in FIG. 5, the option to create an irrigation schedule template can be displayed as a text box 2002 with “Create Schedule Template” and the option to load the irrigation schedule template can be displayed as a text box 2004 with “Load Template.” If the mobile electronic device 120 presenting the GUI 2420 includes a touchscreen, the user can select the options by touching the text boxes.

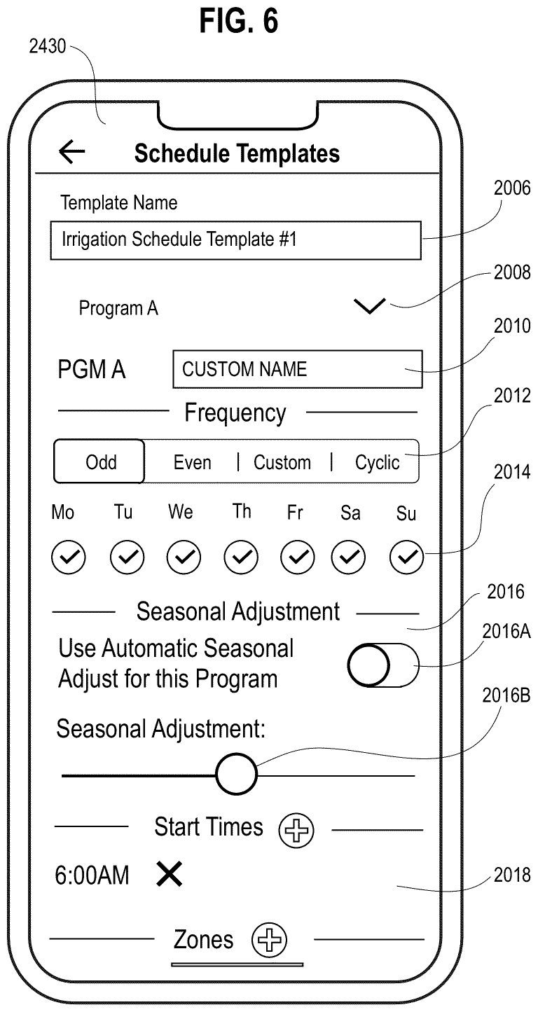

FIG. 6 depicts an example GUI 2430 allowing the user to enter irrigation parameters for the irrigation schedule template. In some embodiments, the irrigation control application 240 allows, via the user interface 242 and using the template module 244, the user to enter the irrigation parameters for the irrigation schedule template. The irrigation parameters can include, but are not limited to, a watering day, a start time, a watering duration, a watering frequency, a seasonal adjustment, and a percentage adjustment. For example, when the user selects the option to create the irrigation schedule template by touching or clicking the text box 2002 of the GUI 2420 in FIG. 4, the irrigation control application 240, using the template module 244 and the display device 208, displays the GUI 2430 to receive irrigation parameters as shown in FIG. 6.

The GUI 2430 includes a template name entry area 2006, a program selection section 2008, a program name entry area 2010, a frequency selection section 2012, a day selection section 2014, a seasonal adjustment section 2016, and a start time selection section 2018. The template name entry area 2006 allows the user to enter a name for the irrigation schedule template the user is creating. The program selection section 2008 provides a list of irrigation programs and allows the user to select a program. In FIG. 6, “Program A” has been selected. The program name entry area 2010 allows the user to customize the program name. The frequency selection section 2012 allows the user to set a frequency with which irrigation will occur (e.g., odd days, even days, a custom frequency, or a cyclic frequency). The user can also select the days on which irrigation will occur via the day selection section 2014. In FIG. 6, the user has selected the odd frequency and the cyclic period to be seven days.

In some embodiments, the user can set the irrigation schedule to be adjusted based on the seasonal adjustments value via the seasonal adjustment section 2016. The GUI 2430 includes a toggle 2016A for automatic seasonal adjustment. The user can turn on the automatic seasonal adjustment function by clicking the toggle 2016A and turning on the automatic seasonal adjustment function. For example, when the irrigation schedule template with the automatic seasonal adjustment turned on is transmitted to the irrigation controller and the irrigation controller is programmed with the transmitted irrigation schedule template, a new daily seasonal adjustment value is sent to the irrigation controller every night. The amount of watering time (i.e., the watering duration parameter) is reduced based on the seasonal adjustment value.

The seasonal adjustment section 2016 includes a seasonal adjustment bar 2016B. In some embodiments, the user can edit the irrigation schedule using a percentage adjustment. For example, the user can adjust seasonal adjustment values by moving the slide of the seasonal adjustment bar 2016B. The seasonal adjustment bar 2016B indicates the amount of watering duration to be reduced compared to the original watering duration parameter entered. For example, when the seasonal adjustment slider is in the middle of the adjustment bar 2016B, it can indicate 100%. When the seasonal adjustment slider is at the left end of the adjustment bar 2016B, it can indicate 0%. When the seasonal adjustment slider is at the right end of the adjustment bar 2016B, it can indicate 200%.

The start time selection section 2018 allows the user to set a start time for the irrigation schedule. As the example depicted in FIG. 6, the irrigation schedule has been set to start at 6:00 AM.

In some embodiments, there may be additional variables that are part of the schedule that can be selected and are not seen in the view of FIG. 6. For example, zone and other setting may be part of the template. The selections described herein are by way of example, and it is understood that a particular template may include any settings, including one or more of the settings described or others.

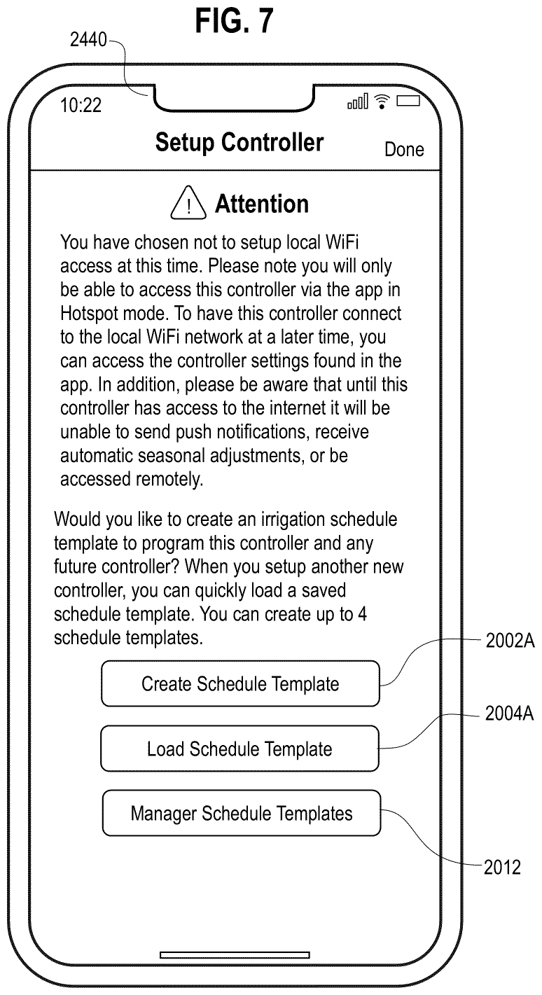

FIG. 7 depicts an example GUI 2440 for setting up an irrigation controller. The GUI 2440 includes a section 2002A for the option to create an irrigation schedule, a section 2004A for the option to load the irrigation schedule templates, and a section 2012 for the option to manage irrigation schedule templates. Although the sections for the options to create or load the irrigation schedule template are included in the GUI 2440 for setting up the irrigation controller, the user can create and load the irrigation template any time, e.g., before/after setting up the irrigation controller or during setting up the controller.

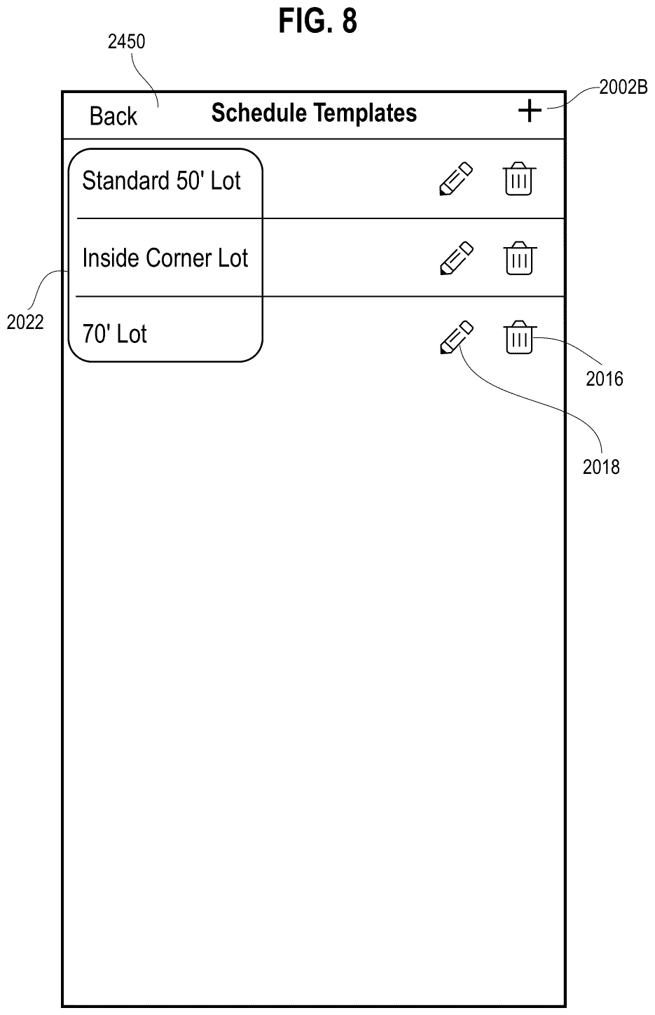

FIG. 8 depicts an example GUI 2450 depicting a list of irrigation schedule templates available for user selection. In some embodiments, the irrigation control application 240 can cause the mobile electronic device 120 to display, via the user interface 242, a list of one or more irrigation schedule templates saved in the memory 202 of the mobile electronic device 120. The user interface 242 displaying the list of irrigation schedule templates can be the GUI 2450. The GUI 2450 includes a section 2022 displaying the list of the irrigation schedule templates having been saved. The GUI 2450 includes a section 2002B for the option to create an irrigation schedule. The section 2022 includes a section 2018 for the option to edit the irrigation schedule template and a section 2016 for the option to delete the irrigation schedule template.

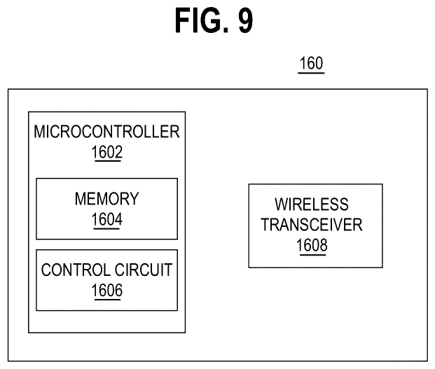

FIG. 9 depicts a block diagram of an example irrigation controller 160, according to some embodiments. In some embodiments, the irrigation controller 160 can include a microcontroller 1602 and a wireless transceiver 1608. The microcontroller 1602 includes a memory 1604 and a control circuit 1606 (e.g., a processor). The control circuit 1606 executes code and provides commands to other components of the irrigation controller 160. The wireless transceiver 1608 allows the irrigation controller 160 to communicate wirelessly. The irrigation controller 160 receives the irrigation schedule template from the mobile electronic device via the wireless transceiver 1608. The irrigation controller saves the received irrigation schedule template in the memory 1604 and executes via the control circuit 1606 the irrigation schedule defined by the irrigation parameters of the irrigation schedule template. In some embodiments, the transceiver 1608 may be integrated into the controller 160 or may be removably connected to the controller 160, e.g., using a radio module such as RAIN BIRD's commercially available LNK WiFi module.

In some embodiments, the irrigation controller 160 can include an input device and a display device. For example, the irrigation controller 160 can include a control panel and the control panel includes both the input device and display device. The control panel can include one or more buttons, dials, switches, displays, and lights which allow the user to define and edit an irrigation schedule. Although the irrigation control application transmits the irrigation schedule template to the irrigation controller 160, the user can define and edit the irrigation schedule using the control panel. The user also can edit the irrigation schedule template transmitted to the irrigation controller using the control panel.

In some embodiments, the irrigation controller 160 does not have a user interface allowing direct programming of an irrigation schedule. For example, the irrigation controller 160 does not have a control panel for the direct programming of an irrigation schedule. Instead, the irrigation controller 160 can be completely configured via the irrigation control application 240 installed on the mobile electronic device 120.

In some embodiments, the irrigation controller 160 can be configured while communicating directly with the mobile electronic device 120. In some embodiments, the only required wireless communication to program the irrigation controller by using the irrigation control application is direct wireless communication. The user can define all irrigation parameters for the irrigation controller 160 by transmitting, via direct communication between the mobile electronic device and the irrigation controller and using the irrigation control application 240, the irrigation schedule template having been saved in the memory of the mobile electronic device.

Configuring the irrigation controller 160 and defining an irrigation schedule via the irrigation control application 240 in the direct communication mode is advantageous because it requires only two devices (i.e., the mobile electronic device 120 and the irrigation controller 160). In these embodiments, the irrigation controller 160 and the mobile electronic device 120 do not need to communicate with or pass information to any remote servers to configure the irrigation controller 160 and define irrigation parameters for the irrigation controller 160. In one form, however, the irrigation schedule can also be defined for the irrigation controller 160 when the mobile electronic device 120 is communicating indirectly with the irrigation controller 160.

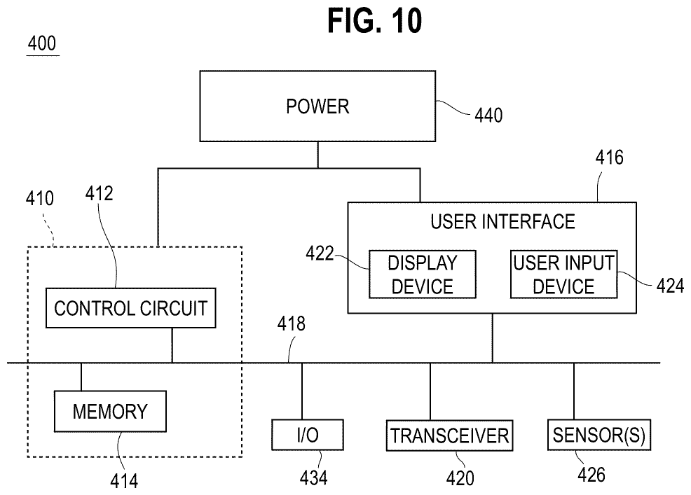

In some embodiments, circuits, circuitry, systems, devices, processes, methods, techniques, functionality, services, sources, and the like described herein may be utilized, implemented and/or run on many different types of devices and/or systems. FIG. 10 illustrates an exemplary system 400 that may be used for implementing any of the components, circuits, circuitry, systems, functionality, apparatuses, processes, or devices of the system 100 for programming an irrigation controller of FIG. 1, the system 200 for programming more than one irrigation controller of FIG. 2, the system 300 for programming irrigation controllers of FIG. 3, and irrigation control, operations of the irrigation control applications for programming irrigation controller of FIG. 4, GUIs 2420, 2430, 2440, 2450 of FIG. 5 to FIG. 8, the irrigation controller 160 of FIG. 9 and/or other above or below mentioned systems or devices, or parts of such circuits, circuitry, functionality, systems, apparatuses, processes, or devices. For example, the system 400 may be used to implement some or all of the mobile electronic device 120, the irrigation controller 160, the router 60, the modem 80, the memory 202 of the mobile electronic device, the control circuit 204 of the mobile electronic device, the display device 208 and input device 212 of the mobile electronic device, transceiver 214 of the mobile electronic device, microcontroller 1602 of the irrigation controller, input device and display device of the irrigation controller, wireless transceiver 1608 of the irrigation controller, and/or other such components, circuitry, functionality and/or devices. However, the use of the system 400 or any portion thereof is certainly not required.

By way of example, the system 400 may comprise a control circuit 412 (e.g., processor module), memory 414, and one or more communication links 418, paths, buses, or the like. Some embodiments may include one or more user interfaces 416, and/or one or more internal and/or external power sources or supplies 440. The control circuit 412 can be implemented through one or more processors, microprocessors, central processing unit, logic, local digital storage, firmware, software, and/or other control hardware and/or software, and may be used to execute or assist in executing the steps of the processes, methods, functionality, and techniques described herein, and control various communications, decisions, programs, content, listings, services, interfaces, logging, reporting, etc. Further, in some embodiments, the control circuit 412 can be part of control circuitry and/or a control system 410, which may be implemented through one or more processors with access to one or more memory 414 that can store instructions, code, and the like that is implemented by the control circuit and/or processors to implement intended functionality. In some applications, the control circuit and/or memory may be accessed over and/or distributed over a communications network (e.g., LAN, WAN, Internet) providing distributed and/or redundant processing and functionality.

The user interface 416 can allow a user to interact with the system 400 and receive information through the system. In some instances, the user interface 416 includes a display 422 and/or one or more user inputs 424, such as buttons, touch screen, trackball, keyboard, mouse, etc., which can be part of or wired or wirelessly coupled with the system 400. Typically, the system 400 further includes one or more communication interfaces, ports, transceivers 420, and the like allowing the system 400 to communicate over a communication bus, a distributed computer, and/or communication network (e.g., LAN, WAN, Internet, etc.), communication link 418, other networks or communication channels with other devices and/or other such communications or combination of two or more of such communication methods. Further, the transceiver 420 can be configured for wired, wireless, optical, fiber optical cable, satellite, or other such communication configurations or combinations of two or more of such communications. Some embodiments include one or more input/output (I/O) ports 434 that allow one or more devices to couple with the system 400. The I/O ports can be substantially any relevant port or combinations of ports, such as but not limited to USB, Ethernet, or other such ports. The I/O interface 434 can be configured to allow wired and/or wireless communication coupling to external components. For example, the I/O interface can provide wired communication and/or wireless communication (e.g., Wi-Fi, Bluetooth, cellular, RF, and/or other such wireless communication), and in some instances may include any known wired and/or wireless interfacing device, circuit and/or connecting device, such as but not limited to one or more transmitters, receivers, transceivers, or combination of two or more of such devices.

In some embodiments, the system may include one or more sensors 426. The sensors can include substantially any relevant sensor, such as acoustic or sound sensors, temperature sensors, rain sensors, and other such sensors. The foregoing examples are intended to be illustrative and are not intended to convey an exhaustive listing of all possible sensors. Instead, it will be understood that these teachings will accommodate sensing any of a wide variety of circumstances in a given application setting.

The system 400 comprises an example of a control and/or processor-based system with the control circuit 412. Again, the control circuit 412 can be implemented through one or more processors, controllers, central processing units, logic, software, and the like. Further, in some implementations, the control circuit 412 may provide multiprocessor functionality.

The memory 414, which can be accessed by the control circuit 412, typically includes one or more processor readable and/or computer readable media accessed by at least the control circuit 412, and can include volatile and/or nonvolatile media, such as RAM, ROM, EEPROM, flash memory and/or other memory technology. Further, the memory 414 is shown as internal to the control system 410; however, the memory 414 can be internal, external or a combination of internal and external memory. Similarly, some or all of the memory 414 can be internal, external or a combination of internal and external memory of the control circuit 412. The external memory can be substantially any relevant memory such as, but not limited to, solid-state storage devices or drives, hard drives, one or more of a universal serial bus (USB) stick or drive, flash memory secure digital (SD) card, other memory cards, and other such memory or combinations of two or more of such memory. The memory 414 can store code, software, executables, scripts, data, patterns, thresholds, lists, programs, log or history data, and the like. While FIG. 6 illustrates the various components being coupled together via a bus, it is understood that the various components may actually be coupled to the control circuit and/or one or more other components directly.

In some embodiments, a system for programming irrigation controllers comprises an irrigation control application stored on a memory of a mobile electronic device and, when executed by a processor of the mobile electronic device, configured to wirelessly communicate with a remote irrigation server, wirelessly communicate with each of a plurality of irrigation controllers, each of the plurality of irrigation controllers having a wireless transceiver, provide, via a user interface and using a template module of the irrigation control application, a user an option to create an irrigation schedule template, allow, via the user interface and using the template module, the user to enter parameters for the irrigation schedule template, save, using the template module, the irrigation schedule template with the parameters in the memory of the mobile electronic device but not saved at the remote irrigation server, wirelessly communicate with a first one of the plurality of irrigation controllers, provide, via the user interface and using the template module, the user an option to load the irrigation schedule template having been saved in the memory, provide, via the user interface and using the template module, the user an option to edit the irrigation schedule template having been loaded, provide, via the user interface and using the template module, the user an option to transmit the irrigation schedule template to the first one of the plurality of irrigation controllers, cause the mobile electronic device to wirelessly transmit the irrigation schedule template to the first one of the plurality of irrigation controllers, the first one of the plurality of irrigation controllers configured to save and execute an irrigation schedule defined by the parameters of the irrigation schedule template, wirelessly communicate with a second one of the plurality of irrigation controllers, provide, via the user interface and using the template module, the user an option to load the irrigation schedule template having been saved in the memory, provide, via the user interface and using the template module, the user an option to edit the irrigation schedule template having been loaded, provide, via the user interface and using the template module, the user an option to transmit the irrigation schedule template to the second one of the plurality of irrigation controllers, and cause the mobile electronic device to wirelessly transmit the irrigation schedule template to the second one of the plurality of irrigation controllers, the second one of the plurality of irrigation controllers configured to save and execute the irrigation schedule defined by the parameters of the irrigation schedule template.

In some embodiments, a method for programming irrigation controllers comprises providing, via a user interface and using a template module of an irrigation control application stored on a memory of a mobile electronic device and executed by a processor of the mobile electronic device, a user an option to create an irrigation schedule template, allowing, via the user interface and using the template module, the user to enter parameters for the irrigation schedule template, saving, using the template module, the irrigation schedule template with the parameters in the memory of the mobile electronic device but not saved at a remote irrigation server, wirelessly communicating with a first one of a plurality of irrigation controllers, providing, via the user interface and using the template module, the user an option to load the irrigation schedule template having been saved in the memory, providing, via the user interface and using the template module, the user an option to edit the irrigation schedule template having been loaded, providing, via the user interface and using the template module, the user an option to transmit the irrigation schedule template to the first one of the plurality of irrigation controllers, causing the mobile electronic device to wirelessly transmit the irrigation schedule template to the first one of the plurality of irrigation controllers, the first one of the plurality of irrigation controllers configured to save and execute an irrigation schedule defined by the parameters of the irrigation schedule template, wirelessly communicating with a second one of the plurality of irrigation controllers, providing, via the user interface and using the template module, the user an option to load the irrigation schedule template having been saved in the memory, providing, via the user interface and using the template module, the user an option to edit the irrigation schedule template having been loaded, providing, via the user interface and using the template module, the user an option to transmit the irrigation schedule template to the second one of the plurality of irrigation controllers, and causing the mobile electronic device to wirelessly transmit the irrigation schedule template to the second one of the plurality of irrigation controllers, the second one of the plurality of irrigation controllers configured to save and execute the irrigation schedule defined by the parameters of the irrigation schedule template, wherein the irrigation control application is configured to wirelessly communicate with the remote irrigation server.

In some embodiments, a system for programming irrigation controllers, comprises an irrigation control application stored on a memory of a mobile electronic device and, when executed by a processor of the mobile electronic device, configured to wirelessly communicate with a remote irrigation server, wirelessly communicate with each of a plurality of irrigation controllers, each of the plurality of irrigation controllers having a wireless transceiver, provide, via a user interface and using a template module of the irrigation control application, a user an option to create an irrigation schedule template, allow, via the user interface and using the template module, the user to enter parameters for the irrigation schedule template, save, using the template module, the irrigation schedule template with the parameters in the memory of the mobile electronic device but not saved at the remote irrigation server, wirelessly communicate with a first one of the plurality of irrigation controllers, provide, via the user interface and using the template module, the user an option to load the irrigation schedule template having been saved in the memory, provide, via the user interface and using the template module, the user an option to edit the irrigation schedule template having been loaded, provide, via the user interface and using the template module, the user an option to transmit the irrigation schedule template to the first one of the plurality of irrigation controllers, and cause the mobile electronic device to wirelessly transmit the irrigation schedule template to the first one of the plurality of irrigation controllers, the first one of the plurality of irrigation controllers configured to save and execute an irrigation schedule defined by the parameters of the irrigation schedule template.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

1. A system for programming irrigation controllers, comprising:
an irrigation control application stored on a memory of a mobile electronic device and, when executed by a processor of the mobile electronic device, configured to:
wirelessly communicate with a remote irrigation server;
wirelessly communicate with each of a plurality of irrigation controllers, each of the plurality of irrigation controllers having a wireless transceiver;
provide, via a user interface and using a template module of the irrigation control application, a user an option to create an irrigation schedule template;
allow, via the user interface and using the template module, the user to enter parameters for the irrigation schedule template;
save, using the template module, the irrigation schedule template with the parameters in the memory of the mobile electronic device but not saved at the remote irrigation server;
wirelessly communicate with a first one of the plurality of irrigation controllers;
provide, via the user interface and using the template module, the user an option to load the irrigation schedule template having been saved in the memory;
provide, via the user interface and using the template module, the user an option to edit the irrigation schedule template having been loaded;
provide, via the user interface and using the template module, the user an option to transmit the irrigation schedule template to the first one of the plurality of irrigation controllers;
cause the mobile electronic device to wirelessly transmit the irrigation schedule template to the first one of the plurality of irrigation controllers, the first one of the plurality of irrigation controllers configured to save and execute an irrigation schedule defined by the parameters of the irrigation schedule template;
wirelessly communicate with a second one of the plurality of irrigation controllers;
provide, via the user interface and using the template module, the user an option to load the irrigation schedule template having been saved in the memory;
provide, via the user interface and using the template module, the user an option to edit the irrigation schedule template having been loaded;
provide, via the user interface and using the template module, the user an option to transmit the irrigation schedule template to the second one of the plurality of irrigation controllers; and
cause the mobile electronic device to wirelessly transmit the irrigation schedule template to the second one of the plurality of irrigation controllers, the second one of the plurality of irrigation controllers configured to save and execute the irrigation schedule defined by the parameters of the irrigation schedule template.

2. The system of claim 1 wherein the irrigation control application is configured to wirelessly communicate with each of the plurality of irrigation controllers one at a time.

3. The system of claim 1 wherein the irrigation control application is configured to wirelessly communicate with each of the plurality of irrigation controllers by using one or more of: direct wireless communication with one or more of the plurality of irrigation controllers, indirect wireless communication with one or more of the plurality of irrigation controllers via a local access point, indirect wireless communication with one or more of the plurality of irrigation controllers via one or more of the local access point, a local gateway, a cellular network, an internet, and a satellite network.

4. The system of claim 3 wherein the only required wireless communication is the direct wireless communication.

5. The system of claim 1 wherein the irrigation control application is configured to save, using the template module, the irrigation schedule template with the parameters only in the memory of the mobile electronic device.

6. The system of claim 1 wherein the irrigation control application is configured to allow, via the user interface and using the template module, the user to enter a name for the irrigation schedule template.

7. The system of claim 1 wherein the irrigation control application is configured to allow, via the user interface and using the template module, the user to delete the saved irrigation schedule template without any signaling to the remote irrigation server.

8. The system of claim 1 wherein the irrigation control application is configured to save, using the template module, a plurality of irrigation schedule templates in the memory of the mobile electronic device but not saved at the remote irrigation server.

9. The system of claim 1 wherein the irrigation control application is configured to display, via the user interface, a list of one or more irrigation schedule templates saved in the memory of the mobile electronic device.

10. The system of claim 1 wherein the irrigation control application is configured to provide, via the user interface and using the template module, the user an option to edit the irrigation schedule template using a percentage adjustment.

11. The system of claim 1 wherein the irrigation control application is one of: an add on application separate from an operating system of the mobile electronic device and installed on the mobile electronic device; and integrated into the operating system of the mobile electronic device.

12. The system of claim 1 wherein the irrigation control application is configured to receive weather adjustment signaling from the remote irrigation server.

13. The system of claim 1 wherein each of the first irrigation controller and the second irrigation controller do not have a user interface allowing direct programming of an irrigation schedule.

14. The system of claim 1 wherein the parameters for the irrigation schedule template comprise one or more of a watering day, a start time, a watering duration, a watering frequency, and a percentage adjustment.

15. A method for programming irrigation controllers, comprising:
providing, via a user interface and using a template module of an irrigation control application stored on a memory of a mobile electronic device and executed by a processor of the mobile electronic device, a user an option to create an irrigation schedule template;
allowing, via the user interface and using the template module, the user to enter parameters for the irrigation schedule template;
saving, using the template module, the irrigation schedule template with the parameters in the memory of the mobile electronic device but not saved at a remote irrigation server;
wirelessly communicating with a first one of a plurality of irrigation controllers;
providing, via the user interface and using the template module, the user an option to load the irrigation schedule template having been saved in the memory;
providing, via the user interface and using the template module, the user an option to edit the irrigation schedule template having been loaded;
providing, via the user interface and using the template module, the user an option to transmit the irrigation schedule template to the first one of the plurality of irrigation controllers;
causing the mobile electronic device to wirelessly transmit the irrigation schedule template to the first one of the plurality of irrigation controllers, the first one of the plurality of irrigation controllers configured to save and execute an irrigation schedule defined by the parameters of the irrigation schedule template;
wirelessly communicating with a second one of the plurality of irrigation controllers;
providing, via the user interface and using the template module, the user an option to load the irrigation schedule template having been saved in the memory;
providing, via the user interface and using the template module, the user an option to edit the irrigation schedule template having been loaded;
providing, via the user interface and using the template module, the user an option to transmit the irrigation schedule template to the second one of the plurality of irrigation controllers; and
causing the mobile electronic device to wirelessly transmit the irrigation schedule template to the second one of the plurality of irrigation controllers, the second one of the plurality of irrigation controllers configured to save and execute the irrigation schedule defined by the parameters of the irrigation schedule template;
wherein the irrigation control application is configured to wirelessly communicate with the remote irrigation server.

16. The method of claim 15 wherein the step of wirelessly communicating with the first one of the plurality of irrigation controllers and the step of wirelessly communicating with the second one of the plurality of irrigation controllers use one or more of: direct wireless communication with one or more of the plurality of irrigation controllers, indirect wireless communication with one or more of the plurality of irrigation controllers via a local access point, indirect wireless communication with one or more of the plurality of irrigation controllers via one or more of the local access point, a local gateway, a cellular network, an internet, and a satellite network.

17. The method of claim 15 wherein the saving step comprises saving, using the template module, the irrigation schedule template with the parameters only in the memory of the mobile electronic device.

18. The method of claim 15 further comprising allowing, via the user interface and using the template module, the user to delete the saved irrigation schedule template without any signaling required to the remote irrigation server.

19. The method of claim 15 further comprising saving, using the template module, a plurality of irrigation schedule templates in the memory of the mobile electronic device but not saved at the remote irrigation server.

20. A system for programming irrigation controllers, comprising:
an irrigation control application stored on a memory of a mobile electronic device and, when executed by a processor of the mobile electronic device, configured to:
wirelessly communicate with a remote irrigation server;
wirelessly communicate with each of a plurality of irrigation controllers, each of the plurality of irrigation controllers having a wireless transceiver;
provide, via a user interface and using a template module of the irrigation control application, a user an option to create an irrigation schedule template;
allow, via the user interface and using the template module, the user to enter parameters for the irrigation schedule template;
save, using the template module, the irrigation schedule template with the parameters in the memory of the mobile electronic device but not saved at the remote irrigation server;
wirelessly communicate with a first one of the plurality of irrigation controllers;
provide, via the user interface and using the template module, the user an option to load the irrigation schedule template having been saved in the memory;
provide, via the user interface and using the template module, the user an option to edit the irrigation schedule template having been loaded;
provide, via the user interface and using the template module, the user an option to transmit the irrigation schedule template to the first one of the plurality of irrigation controllers; and
cause the mobile electronic device to wirelessly transmit the irrigation schedule template to the first one of the plurality of irrigation controllers, the first one of the plurality of irrigation controllers configured to save and execute an irrigation schedule defined by the parameters of the irrigation schedule template.
